(19) United States
(12) Patent Application Publication
(10) Pub. No.: US 2006/0174339 A1
(43) Pub. Date: Aug. 3, 2006

(54) AN ARRANGEMENT AND METHOD OF GRAPHICAL PASSWORD AUTHENTICATION

(76) Inventor: Hai Tao, Gatineau (CA)

Correspondence Address: HAI TAO, 340 CITE-DES-JEUNES, APT. 51, GATIREAU, QC, J8Y-6R4, CA

(21) Appl. No.: 11/163,115

(22) Filed: Oct. 5, 2005

(30) Foreign Application Priority Data
Jan. 29, 2005 (CA) 2495445

(51) Int. Cl. G06F 12/14

(52) U.S. Cl. 726/18

(57) ABSTRACT

A graphical password authentication arrangement and method display a grid on a display upon a user's request to access a restricted resource. The graphical password authentication arrangement requires the user to enter his or her access password by selecting one or more intersections on the grid on the display with an input device. A processing means determines whether to grant the user to access the restricted resource by comparing the access password entered with a corresponding file password for the user, which is stored in a storage means.

### FIELD OF THE INVENTION

This invention relates to graphical password authentication schemes.

### BACKGROUND OF THE INVENTION

Conventional textual password scheme uses a string of alphanumeric characters to identify a user. As people tend to choose inherently weak passwords, i.e. those passwords easy to remember, instead of strong password, textual password scheme is vulnerable to be attacked.

Graphical password schemes, which take advantage of a person's significant capability to recognize and to recall visual images, will resolve the problems associated with textual password scheme.

U.S. Pat. No. 5,559,961 to Blonder, issued Sep. 24, 1996, for example, discloses a graphical password scheme, in which a user is presented with a predetermined graphical image and is required to select one or more predetermined positions (“tap regions”) on the image in a predetermined sequence, as a means of entering a password. The drawback of such a scheme is that the memorable tap regions are usually limited and this leads to a limited effective password space.

Similarly, U.S. Pat. No. 5,608,387 to Davies, issued Mar. 4, 1997, teaches another graphical password scheme. Under this scheme, a user is required to select one or more complex human face images as a password. This scheme also suffers from the relatively small password space. For instance, in the case of a 3×4 face matrix, if the length of the password is 6, the full password space amounts to 12⁶˜3 millions.

U.S. Pat. No. 6,686,931 to Bodnar, issued Feb. 3, 2004, discloses a graphical password methodology for a microprocessor device that accepts non-alphanumeric user input. The graphical password comprises a sequence of non-alphabetic keystrokes, such as FORWARD, FORWARD, BACK, BACK, SELECT. The full password space of this scheme is even smaller.

In 1999, lan Jermyn proposed a graphical password scheme, “draw a secret”, in which a user is required to draw a secret design on a grid. [In his paper entitled “The Design and Analysis of Graphical Passwords” in Proceedings of the 8^{th} USENIX Security Symposium, August 1999] However, in this scheme, many passwords are difficult to remember and repeat, since “difficulties might arise however, when the user chooses a drawing that contains stokes that pass too close to a grid-line”. The author gave a tentative solution: “the system does not accept a drawing which contains strokes that are located ‘too close’ to a grid line”. However, it is very difficult to define how close is “too close” in this scheme. Users have to draw their input sufficiently away from the grid lines and intersections in order to enter the password correctly. If a user draws a password close to the grid lines or intersections, the scheme can not distinguish which cell the user is choosing. This limitation causes this scheme to require that the cells must be sufficiently large and must not be too small. This limitation also sacrifices the easiness of inputting password, restricts freedom of choosing password (or shapes of drawings), and subsequently reduces the effective password space for this scheme.

In addition, almost all graphical password schemes are subject to shoulder surfing, namely other people can get a user's password easily by watching the user entering his or her password.

### SUMMARY OF THE INVENTION

This invention is directed to overcome the foregoing problems and disadvantages of the prior art. In the present invention, a user seeking access to a restricted resource is presented with a gird on a display and is required to select one or more intersections on the grid as a way of indicating his or her authorization to access the restricted resource.

The invention possesses numerous advantages over the prior art. Firstly, this invention makes use of intersections of a grid instead of using cells of the grid to improve repeatability and easiness of entering password. Secondly, the invention takes advantage of the psychological theory that human has significant capability of recognizing and recalling a visual image than a word. Users can remember a visual password by remembering the corresponding shape of indicators. For example, line indicators can form many alphanumeric characters in different size. This feature could be further exploited in some Asian countries, such as China, Japan and Korea, where users can draw their own characters of their own languages on the grid. Thirdly, the invention makes use of visual referencing aid to help users to remember their passwords. This expands the memorable password space. Fourthly, by adjusting the size of the grid, the invention can produce different security levels for authentication. For example, in a 5×5 grid, if the password length (the number of the corresponding unique values associated with selected intersections) is 6, the full password space is (5×5)⁶=2.44×10⁸. While in a 13×13 grid, if the password length is also 6, the full password space is (13×13)⁶=2.33×10¹³.

Below is the comparison of the full password spaces of different size grids.

| | length = 4 | length = 5 | length = 6 | length = 7 | length = 8 |
|---|---|---|---|---|---|
| m = 5, n = 5 | 3.91 × 10⁵ | 9.77 × 10⁶ | 2.44 × 10⁸ | 6.10 × 10⁹ | 1.53 × 10¹⁰ |
| m = 7, n = 7 | 5.76 × 10⁶ | 2.82 × 10⁸ | 1.38 × 10¹⁰ | 6.78 × 10¹¹ | 3.32 × 10¹³ |
| m = 9, n = 9 | 4.30 × 10⁷ | 3.49 × 10⁹ | 2.82 × 10¹¹ | 2.29 × 10¹³ | 1.85 × 10¹⁵ |
| m = 13, n = 13 | 8.16 × 10⁸ | 1.38 × 10¹¹ | 2.33 × 10¹³ | 3.94 × 10¹⁵ | 6.65 × 10¹⁷ |
| m = 17, n = 19 | 1.09 × 10¹⁰ | 3.52 × 10¹² | 1.14 × 10¹⁵ | 3.67 × 10¹⁷ | 1.18 × 10²⁰ |
| m = 19, n = 19 | 1.70 × 10¹⁰ | 6.13 × 10¹² | 2.21 × 10¹⁵ | 7.99 × 10¹⁷ | 2.88 × 10²⁰ |

Fifthly, as displaying a grid on a display usually requires less system resource, such as memory space and display resolution rate, compared with displaying an image, this invention is more cost-effective. Sixthly, long passwords (the number of corresponding unique values associated with selected intersections is more than eight) can be remembered easily; the effective password space can be considerably expanded further. Seventhly, as the invention is language independent, anyone, including illiterate people and young children, can use the invention without difficulty. Finally, by using disguising indicators, this invention effectively resolves the shoulder surfing problem.

According to one aspect of the present invention, it provides an arrangement of graphical password authentication, comprising of a display displaying a grid with a plurality of horizontal and vertical lines on the display upon user's request for accessing a restricted resource, and an input device for the user to enter password by selecting one or more intersections on the grid for a means of entering password. The arrangement may optionally further comprise a storage means for storing a file password, and a processing means for comparing an access password entered by the user for accessing the restricted resource with the corresponding file password for the user stored in the storage means.

According to another aspect of the present invention, it provides a graphical password authentication method, comprising steps of displaying a grid with a plurality of horizontal and vertical lines on a display upon user's request, and entering an access password by the user using an input device by selecting one or more intersections on the grid. The method may optionally further comprise steps of storing a file password in a storage means, and comparing the entered access password for the user with the corresponding file password for the user stored in the storage means to determine whether access should be granted.

### BRIEF DESCRIPTION OF THE DRAWINGS

The invention will now be described in more detail with reference to the accompanying drawings, in which:

FIG. 1 shows an interface, which displays a grid along with reference dots and reference cells on a display;

FIG. 2 shows locating scopes corresponding to each intersection;

FIG. 3 shows indicators are being displayed when a user selects intersections;

FIG. 4 shows disguising indicators are being used to prevent onlookers from misappropriating a user's access password; and

FIG. 5 is a flow diagram illustrating the invention.

### DETAILED DESCRIPTION OF THE INVENTION

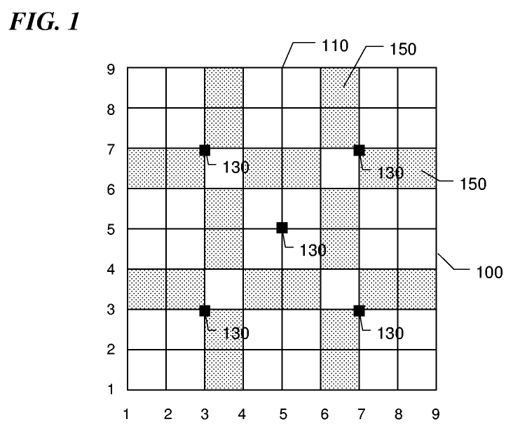

Referring to the drawings, FIG. 1 shows an interface, which displays a grid 100 along with reference aids, including reference dots 130 and reference cells 150, on a display. The display can be a monitor of a computer, a screen of a terminal, a screen of a Personal Digital Assistant (PDA) or any other user login interfaces. When a user requests to access a restricted resource, the grid 100 along with reference aids are shown on the display. The grid 100 comprises of two or more horizontal lines and two or more vertical lines. The lines can be curved or distorted to prevent machine-based attack. The number of vertical lines is defined as m, and the number of horizontal lines is defined as n, respectively, where m and n are integers, which are greater than one.

Each intersection 110 on the grid 100 has a unique value associated with it. The value is denoted by a coordinate (x, y) ∈ [1 . . . m]×[1 . . . n].

Visual aid for referencing position (or reference aid) may be displayed inside the grid 100 to assist a user to memorize and to correctly enter the password. Such reference aid could be dots inside the grid 100, different type (i.e. bold or dashed lines) of horizontal and vertical lines, and/or colored, shaded, patterned cells inside the grid 100. The number and position of reference aids are predefined. The number of reference aids could be zero. The reference aids can have a specific shape, size, pattern and color. The shape, size and color of reference aids are predefined.

In FIG. 1, reference dots 130 and reference cells 150 are used as reference aids to help users to memorize their passwords. In FIG. 1, reference dots 130 are illustrated as small black squares; reference cells 150 are illustrated as shaded cells.

A user is required to select one or more intersections 110 on the grid 100 as a means of entering his or her password. The input device could be a mouse, a stylus, a keyboard or any other suitable input devices.

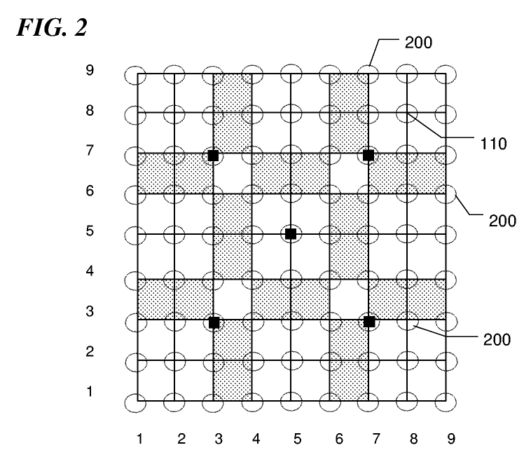

FIG. 2 shows locating scopes 200, which correspond to each intersection 110. A locating scope 200 is defined as an area surrounding an intersection 110. The purpose of the locating scope 200 is to increase the possibility for a user to select the intersection 110 successfully. The locating scope 200 has a specific size and shape, which are predefined. Locating scopes 200 are invisible to the users. In other words, the locating scopes 200 are not shown on a display.

A user may select intersections 110 either intermittently or continuously. [Para 28] Selecting intersections 110 intermittently means that the user selects one intersection 110 at one time. A user can click, touch or tap on anywhere inside of the corresponding locating scope 200 with an input device.

Selecting intersections 110 continuously means that a user selects two or more intersections 110 sequentially without a break with an input device. To select intersections 110 continuously, a user can pass through the corresponding locating scopes 200 with input device sequentially without a break.

Below we give an example of the operations of selecting intersections 110 continuously. In practice, software and hardware designers can define their own operation rules.

If input device is a mouse, a user can start by pressing down and holding the left button of the mouse on a starting intersection 110. The user then continues to drag the mouse while keep holding the left button. All the intersections 110 with corresponding locating scopes 200 which the mouse pointer passed through are selected. Releasing the left button ends the selection.

If input device is a stylus, the operation could be simpler. A user can simply pass through the corresponding locating scopes 200 on the display with the stylus. All the intersections 110 whose corresponding locating scopes 200 have been touched by the stylus are selected. Lifting the stylus from the display surface ends the selection.

Means to indicate or notify the user acknowledging their input is often quite useful. Such indicator means may be visual dots, lines or audible sound generated simultaneously in response to the user input. Alternatively, it may be visual indicator located outside the grid, displaying an indicator with predetermined shape, size and color simultaneously in response to the user input.

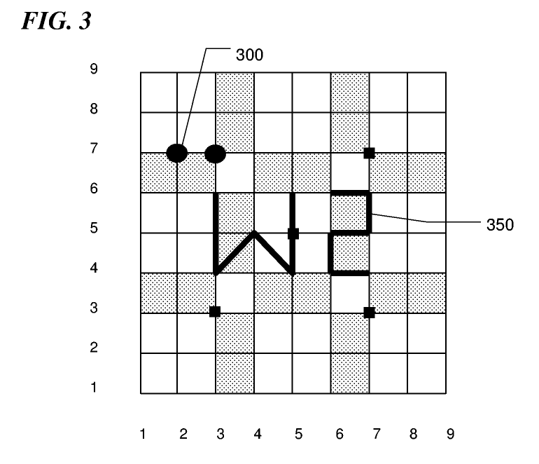

FIG. 3 shows how visual indicators are displayed when a user selects the intersections 110 as his or her password.

When a user selects intersections 110 intermittently, a dot indicator 300 may appear on the selected intersection 110 in response to each selection. Dot indicators 300 have specific shape, size and color. The shape, size and color of dot indicators 300 are predetermined. In FIG. 3, dot indicators 300 are black circles.

Whenever two intersections are selected continuously, a line indicator 350 appears from the first selected intersection to the second selected intersection. A line indicator 350 could be horizontal, vertical or diagonal. Line indicators 350 have a specific shape, size, style and color. The shape, size, style and color of line indicators 350 are predefined. In FIG. 3, the line indicators 350 are black bolded lines.

An intersection 110 can be selected more than one time. If an intersection 110 is selected intermittently more than one time, only one dot indicator 300 may be displayed. If two intersections 110 are selected continuously more than one time, only one line indicator 350 may be displayed.

In order to draw a password like illustrated in FIG. 3, for example, a user select intersection (2,7) and (3,7) intermittently by clicking any point inside the corresponding locating scopes 200 of the intersections 110 with the input device. The dot indicators 300 appear simultaneously in response to the user selects the intersections accordingly.

Then the user selects intersections 110 continuously to draw a shape of letter “W” with one stroke. In order to draw this using a mouse, for example, the user can press the left button (select button) of the mouse on the starting intersection (3,6), and pass through (3,5) while keeps holding the left button of the mouse. As soon as the mouse touches the corresponding locating scope 200 of the intersection (3,5), a line indicator 350 appears from (3,6) to (3,5). Then, the user passes from (3,5) through (3,4), (4,5), (5,4), (5,5), and to the end intersection (5,6), and then, release the left button. Line indicators 350 appear correspondingly to shape the letter “W” as shown in FIG. 3. To draw a shape of “2” with one stroke, the user selects continuously using the mouse by holding the left button down from the starting intersection (6,6), pass through (7,6), (7,5), (6,5), and (6,4), to the end intersection (7,4), and then release the button. Line indicators 350 appear correspondingly.

A “pen-up” event happens whenever a user releases the left button (or lift the stylus from the display surface) after and only after a user selected two or more intersections continuously. A specific value, or pen-up value, which is expressed in the same manner as for the intersection but is a different value from ones for intersections, is used to denote the “pen-up” event, i.e., ((m+1), (n+1)). In FIG. 3, as m=9 and n=9, so “pen-up” event may be denoted by coordinate (10,10). The value of “pen-up” event (or pen-up value) may be inserted into the sequence of selecting intersections to indicate where and when the break happens while a user selects intersections continuously. When the user selects intersections intermittently by clicking or tapping one intersection at a time, there is no “pen-up” event happened.

In FIG. 3, the password can be, then, denoted by a coordinate sequence with “pen-up” events as follows:

(2,7), (3,7), (3,6), (3,5), (3,4), (4,5), (5,4), (5,5), (5,6), (10,10), (6,6), (7,6), (7,5), (6,5), (6,4), (7,4), (10,10)

In this case, the length of the password is 17.

Although this password is very long, we still can remember it by remembering two dots and letter “W” and number “2”.

Two passwords are deemed to be identical if they can be denoted by the same length and same coordinate sequence.

An access password is a password, which a user enters to request access to a restricted resource. A file password is a password that stored in a storage means, which may be individually configured by the user or by a system administrator, or may be configured randomly by a processing means. File passwords can be encrypted by a processing means using an encryption algorithm, and the result of the encryption is stored in a storage means of this arrangement to improve the security of passwords. After the user enters his or her access password, processing means encrypts the access password and compares the result with the encrypted file password stored in the storage means, and decides whether the user is granted the access to a restricted resource.

The password could also be a set of selected intersections, namely the sequence in which the intersections are selected and the “pen-up” event are immaterial. In the case of FIG. 3, the password can be denoted by a set of coordinates:

{(2,7), (3,7), (3,6), (3,5), (3,4), (4,5), (5,4), (5,5), (5,6), (6,6), (7,6), (7,5), (6,5), (6,4), (7,4)}

In this case, the length of the password is 15.

This option allows passwords to be memorized easily and, at the same time, reduces password space.

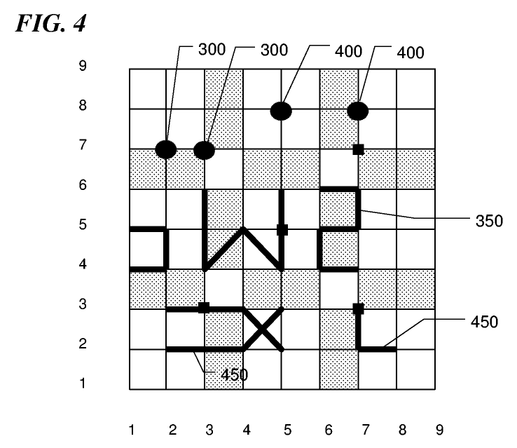

FIG. 4 shows how disguising indicators can prevent onlookers from getting the passwords.

To prevent onlookers from stealing a user's password by watching in the user's vicinity, disguising indicators can be used. In response to the user input, one or more disguising dot indicator 400 or disguising line indicator 450 may be displayed on randomly chosen positions along with the true dot indicator 300 or line indicator 350. A disguising dot indicator 400 and disguising line indicator 450 has the same style, shape, color and size as the real dot indicator 300 and line indicator 350.

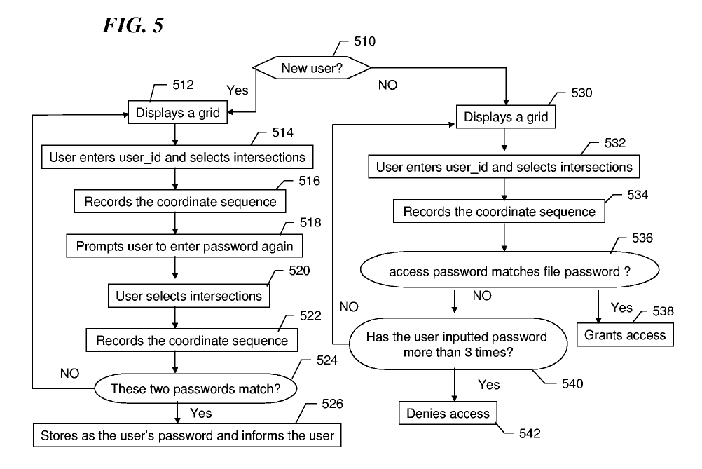

FIG. 5 is a flow diagram to illustrate how the invention can be used.

The steps for a user to create a new file password are as follows:

A grid 100 and reference aids including reference dots 200 and reference cells 250 are displayed on the display, at step 51 2. The user is, then, required to select one or more intersections 110 on the grid 100. After the user completes entering his or her file password by selecting one or more intersections 110 on the grid 100, at step 514, the corresponding coordinate sequence is recorded, at step 516, and the user is prompted to enter his or her file password again, at step 518. After the user inputs his or her file password for the second time, at step 520, the corresponding coordinate sequence is recorded, at step 522. These two coordinate sequences are compared by a processing means, at step 524. If they match, this coordinate sequence is stored in a storage means as the user's new file password, and the user is informed that the file password has been successfully created, at step 526. If they do not match, the user is informed that these two file passwords do not match and the user is required to input his or her file password again from the beginning, until the user inputs two identical file passwords.

After a new file password is created, a user is required to enter his or her access password before he or she is given access to a restricted resource. When a user requests to access to the restricted resource, a grid 100 and reference aid including reference dots 200 and reference cells 250 are displayed on the display, and the user is required to select one or more intersections 110 on the grid 100 at step 530. After the user completes entering his or her access password by selecting one or more intersections 110 on the grid 100, at step 532, the corresponding coordinate sequence is recorded, at step 534. The processing means compares this access password with the corresponding file password for the user stored in the storage means at step 536. If they match, the user is granted to access to the restricted resource at step 538; if they do not match and the user has entered an access password for three times or more, the user is denied access the restricted resource, at step 542; if they do not match and the user has not entered the access password for three times or more, the user is informed that the access password he or she entered is incorrect, and is required to enter his or her access password again. The number of attempts that a user is allowed to enter wrong password consecutively is predefined. In our example here, the times that a user is allowed to enter wrong password consecutively is three.

While the invention has been described with reference to preferred embodiments, it will be understood by those skilled in the art that various changes may be made and equivalent elements may be substituted for elements of the invention without departing from the scope of the present invention. In addition, modifications may be made to adapt a particular situation to the teachings of the present invention without departing from the essential scope thereof. Therefore, it is intended that the invention not be limited to the particular embodiment disclosed as the best mode contemplated for carrying out this invention, but that the invention include all embodiments falling within the scope of the appended claims.

What is claimed is:

1. A graphical password authentication arrangement comprising:
a. a display for displaying a grid with a plurality of horizontal and vertical lines on said display upon a user's request for accessing a restricted resource; and
b. an input device for entering a password by said user by selecting one or more intersections on said grid on said display.

2. The arrangement as recited in claim 1, wherein said horizontal and vertical lines are curved or distorted.

3. The arrangement as recited in claims 1, wherein said display includes predetermined number of reference aids, wherein said reference aids are placed at predetermined positions along said grid on said display.

4. The arrangement as recited in claim 3, wherein said reference aid is comprising of a predetermined number of reference dots having predetermined shape, size, and color, wherein said reference dots are placed at predetermined positions along said grid on said display.

5. The arrangement as recited in claim 3, wherein said reference aid is comprising of a predetermined number of reference cells with predetermined color and pattern, wherein said reference cells are placed at predetermined positions along said grid on said display.

6. The arrangement as recited in claim 1, wherein said intersection has a corresponding locating scope around it, whereby said user selects one of said intersections by touching inside an area of said corresponding locating scope with using said input device, wherein said touching includes tapping inside said area of said locating scope and passing through said area of said locating scope with said input device.

7. The arrangement as recited in claim 6, wherein said locating scope of said intersection has a predetermined size and shape.

8. The arrangement as recited in claim 1, wherein an indicator means is provided to notify and acknowledge the user's input.

9. The arrangement as recited in claim 8, wherein said indicator means is a visual dot indicator appeared simultaneously on selected intersection of said grid as a response to user input, and said visual dot indicator has a predetermined size, shape and color.

10. The arrangement as recited in claim 8, wherein said indicator means is more than one dot indicators appearing simultaneously on intersections including selected intersection of said grid on said display to disguise a true input entered by a user, and said visual dot indicator has a predetermined size, shape and color.

11. The arrangement recited in claim 8, wherein said indicator means is a visual line indicator appeared simultaneously whenever two intersections are continuously selected without a break, and said visual line indicator is drawn from the first selected intersection to the second selected intersection on said grid as a response to user input, and said line indicator has a predetermined style, size, shape and color.

12. The arrangement as recited in claim 8, wherein said indicator means is more than one visual line indicators appearing simultaneously on said grid on said display to disguise a true input entered by a user, and said visual line indicator has a predetermined style, size, shape and color.

13. A graphical password authentication method comprising:
a. displaying a grid with a plurality of horizontal and vertical lines on a display upon a user's request to access a restricted resource; and
b. entering a password by said user using an input device by selecting one or more intersections on said grid.

14. The method as recited in claim 13, wherein said display includes predetermined number of reference aids, and said reference aids are placed at predetermined positions along said grid on said display.

15. The method as recited in claim 14, wherein said reference aid is comprising of a predetermined number of reference dots having predetermined shape, size and color, wherein said reference dots are placed at predetermined positions along said grid on said display.

16. The method as recited in claim 14, wherein said reference aid is comprising of a predetermined number of reference cells with predetermined color and pattern, wherein said reference cells are placed at predetermined positions along said grid on said display.

17. The method as recited in claim 13, wherein an indicator means is used to notify and acknowledge the users input.

18. The method as recited in claim 17, wherein said indicator means is a visual dot indicator appeared simultaneously on selected intersection of said grid as a response to user input, and said visual dot indicator has a predetermined size, shape and color.

19. The method recited in claim 17, wherein said indicator means is a visual line indicator appeared simultaneously whenever two intersections are continuously selected without a break, and said visual line indicator is drawn from the first selected intersection to the second selected intersection on said grid as a response to user input, and said line indicator has a predetermined style, size, shape and color.

20. An article of manufacture comprising:
a. computer-readable program code module for handling user input from an input device;
b. computer-readable program code module for manipulating a display displaying a grid with a plurality of horizontal and vertical lines and requiring the user to enter password by selecting one or more intersections on said grid on said display;
c. computer-readable program code module for manipulating a storage means to register and to store file passwords; and
d. computer-readable program code module for manipulating a processing means for determining user access to a restricted resource by comparing an entered access password with said file password corresponding to said user, wherein said file password is stored in said storage means.
